(19) United States
(12) Patent Application Publication
(10) Pub. No.: US 2026/0072273 A1
(43) Pub. Date: Mar. 12, 2026

(54) Light Control Device

(71) Applicant: Envisics Ltd, Milton Keynes (GB)

(72) Inventors: Daniel Molina, Milton Keynes (GB); Timothy Smeeton, Milton Keynes (GB); Hugo Malin-Clegg, Milton Keynes (GB)

(21) Appl. No.: 19/324,109

(22) Filed: Sep. 9, 2025

(30) Foreign Application Priority Data
Sep. 12, 2024 (GB) 2413433.0

(51) Int. Cl. G02B 27/01; G02B 27/00

(52) U.S. Cl. CPC G02B 27/0103; G02B 27/0081; G02B 27/0149; G02B 2027/0118; G02B 2027/013; G02B 2027/0154

(57) ABSTRACT

Embodiments include a system having a viewing window and arranged to project a first image on a first plane and a second image on a second plane, the system including (i) a replicator arranged to receive spatially modulated light and form a plurality of replicas by waveguiding between a reflective surface and a transmissive-reflective surface forming an output surface, (ii) a light control device in the optical path of the replicas downstream from the output surface, wherein a first plurality of replicas of the first image form a first light footprint on a first area of the light control device and a second plurality of replicas of the second image form a second light footprint on a second area of the light control device, and (iii) a driver arranged to move the light control device relative to the replicator.

### CROSS-REFERENCE TO RELATED APPLICATIONS

This application claims priority under 35 U.S.C. § 119 to UK Patent Application GB 2413433.0 titled “Light Control Device,” filed on Sep. 12, 2024, and currently pending. The entire contents of GB 2413433.0 are incorporated by reference herein for all purposes.

### FIELD

The present disclosure relates to a head-up display suitable for use in a vehicle comprising a light control layer. In some embodiments, the light control layer acts as both a reflection suppression device and a glare mitigation device. The present disclosure further relates to methods of processing display light using the head-up display. More broadly, the present disclosure relates to the light control layer. Some embodiments relate to a holographic projector or picture generating unit.

### INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”.

### SUMMARY

Aspects of the present disclosure are defined in the appended independent claims.

In general terms, there is provided a light control device or glare mitigation device for display light that is arranged to compensate for the curvature of a curved optical component on an optical path of the display light. In embodiments, the light control device or glare mitigation device is for display light of a display system. In embodiments, the curved optical component is on an optical path of the display system. In some embodiments, the curved optical component is an optical combiner, such as a vehicle windscreen, arranged to redirect display light from a display device to a viewing window or so-called eye-box. The optical component may have a first curvature in a first direction and a second curvature in a second direction perpendicular to the first direction. The first and/or second curvature may be non-linear. The optical component has a complex curvature which introduces complex distortions when used in a display system particularly one based on holographic projection.

The display light may be spatially modulated light. The display system may be arranged to relay the spatially modulated light to a viewing plane or eye-box. In some embodiments, the display system is a holographic display system and the spatially modulated light is light that is spatially modulated in accordance with a hologram. The spatially modulated light may be referred to as a holographic wavefront. The light control device of the present disclosure provides a means for controlling reflections of ambient light to prevent or suppress glare from reaching the viewing plane while allowing the spatially modulated light to reach the viewing plane. For example, the display device may comprise an optical component comprising a reflective surface. In the absence of the light control device, ambient light may be reflected by the reflective surface towards the viewing plane/eye-box of the display device thus forming glare. The light control device of the present disclosure is arranged to suppress such reflections.

As above, the light control device of the present disclosure is further arranged to compensate for the curvature of a curved optical component on an optical path of the display system. The curved optical component being on the optical path of the display system may mean that the spatially modulated light, propagating through the display system, may be incident on, reflected by, transmitted through, or otherwise interact with the curved optical component. As the skilled person will appreciate, the curvature of the optical component may alter the divergence or convergence of the spatially modulated light and angles thereof. For example, if the spatially modulated light is substantially collimated upstream of the curved optical component (prior to interacting with the optical component), then the spatially modulated may be non-parallel (e.g. converging or diverging) downstream of the curved optical component (after interacting with the optical component). In other words, the curved optical component may have a lensing effect on the spatially modulated light incident thereon. If the curvature of the curved optical component is non-uniform, then the lensing effect may be non-uniform. For example, different portions of the curved optical component may have a different radius of curvature and so may have a different lensing effect on spatially modulated light incident thereon. In some embodiments, the curved optical component is a windscreen or windshield of a vehicle. A windscreen or windshield may have a complex curvature having a complex lensing effect on display light incident thereon.

The inventors have identified a number of problems associated with the lensing effect of the curved optical component. One problem is that the lensing effect may distort the display light (of the display system). For example, the display light may be such that a picture is viewable at a viewing plane. For example, the display light may be spatially modulated in accordance with a hologram of a picture, or simply in accordance with a picture. The lensing effect of the curved optical component may distort the picture that is viewable at the viewing plane. This may adversely affect a viewing experience of the display system. Another problem identified by the inventors is specific to display systems comprising a replicator, upstream of the curved optical component. The replicator may be arranged to replicate the spatially modulated light to form a plurality of replicas of the spatially modulated light. For example, if the spatially modulated light is a holographic wavefront, the replicator may be arranged to form a plurality of replicas of the holographic wavefront. In embodiments, the replicator may be a waveguide, as described below. For example, the waveguide may comprise an input port arranged to receive the spatially modulated light. The waveguide may comprise a pair of surfaces arranged to waveguide the spatially modulated light received at the input therebetween. A first surface of the pair of surfaces may be partially-transmissive partially-reflective. The first surface may be arranged to form the plurality of replicas of the spatially modulated light. At least a portion of the first surface may be said to form an output port of the replicator/waveguide. The replicator may be arranged such that the plurality of replicas are relayed towards the curved optical component. The display system may be further arranged such that the plurality of replicas are relayed towards a viewing plane/eye-box of the display system. The inventors have found that the pitch of the replicas of the spatially modulated light (at the viewing plane) is important for ensuring a good viewing experience. Through simulation and experimentation, the inventors have further found that the pitch of the replicas may be affected by the lensing effect of the curved optical component. For example, the pitch of the replicas at the viewing plane may be increased or decreased. This may adversely affect the viewing experience. For example, if the pitch of the replicas is reduced, so-called ghosting effects, in which a copy of the intended picture or image content is displayed slightly offset from the intended picture or image content, may become more apparent. The pitch of the replicas may be reduced if the curved optical component has a concave shape, for example the inside surface of a windscreen or windshield. As used herein, the pitch of replicas refers to the separation or distance between the centres of adjacent replicas.

The inventors have previously proposed light control devices/glare mitigation devices for reflection/glare suppression. These can be seen, for example, in British patent GB2607672.

Head-up displays can be single-plane or multi-plane, with the above-described head-up displays being the former. Users (i.e. viewers) perceive the displayed image(s) from a single-plane head-up display at a single distance from their point of view, whereas users perceive the displayed images from a dual-plane head-up display at two different distances from their point of view. Dual-plane head-up displays offer various benefits over their single-plane counterparts. For example, traditional vehicle instrument cluster content including speed, fuel and warning indications can be displayed directly in front of the vehicle, whilst driving hazards and directions can be overlaid in an augmented-reality style that blends in with the driving environment. Therefore, the separation in displayed image depth provided by dual-plane head-up displays enhances the user experience.

Dual-plane head-up displays according to the prior art often use multiple large freeform mirrors to enable the presence of more than one image plane. These large freeform mirrors are also used for the above-described curved optical component mitigation and to position the content at appropriate depths. The large size of these mirrors is undesirable, especially in automotive applications as space in vehicle designs may already be limited between the volume assigned for the head-up display and surrounding features such as crumple zones, ventilation ducts and firewalls. The present disclosure aims to reduce the size of the head-up display without sacrificing its image quality or depth information.

The above-described head-up displays (that are single-plane head-up displays) use the light control devices described above in place of the freeform mirrors for curved optical component mitigation. That is, the applicant's previously disclosed light control devices comprise a freeform Fresnel-type light control device that performs the optical role of the freeform mirrors but with a much smaller volume. These light control devices cover the output surface of an optically downstream waveguide (that is, the waveguide from which replicas arrive at the curved optical component) to correct for the geometry of the curved optical component for a user's full field-of-view from everywhere in the eye-box.

However, it would be very difficult for the light control devices as previously disclosed to be used as a starting point to create a dual-plane (or, more generally, a multi-plane) head-up display. Such a light control device could be designed that, for a given head position of the user, images are displayed at different depths. However, when said user moves their head, the light would arrive at their eyes from a different part of the light control device, resulting in optical anomalies such as image distortions, a change in depth perceived and/or parts of the image missing for parts of the field-of-view. As such, as the user moves their head around the eye-box, the light control device would have to support viewing different regions of the displayed images at different depths through the same part of the light control device. This would be further complicated by the fact that overlapping of the areas (in other words, footprints) of the light control device corresponding to the images to be displayed at different depths prevents the desired images from forming correctly. As such, designing and manufacturing such a light control device for use in a multi-plane head-up display may be prohibitively complex and therefore expensive.

In a first aspect of the invention, a display system is provided. More specifically, a head-up display (system) for a vehicle is provided. The display system has a viewing window (also referred to herein as an eye-box). The viewing window is a virtual area in which the system has been designed such within said area the image(s) displayed by the system are visible to a sufficiently high quality and/or with a sufficiently low number of optical anomalies. The display system is arranged to project (in other words, display) a first image on a first plane and project (or display) a second image on a second plane. The images may be described as virtual images. That is, the display system is arranged to display images on different planes and is therefore a dual-plane system. Although the system is described as having two planes, further planes are also envisaged, and as such the system is more generally a multi-plane system. The display system comprises a replicator arranged to receive spatially modulated light. The replicator may be a waveguide as described herein. The replicator is further arranged to replicate the spatially modulated light to form a plurality of replicas of the spatially modulated light by waveguiding between a reflective surface and a transmissive-reflective surface. The transmissive-reflective surface forms an output surface for the plurality of replicas of the spatially modulated light. The display system further comprises a light control device located in the optical path of the plurality of replicas of the spatially modulated light downstream from the output surface of the replicator. In other words, the light control device is located on an optical path between the output surface of the replicator and the viewing window. The display system may comprise a plurality of replicators, the light control device being located downstream of a downstream replicator. The light control device comprises a first area and a second area. A first plurality of replicas of (or, in other words, according to) the first image form (or, in other words, are output/emitted from) a first light footprint on (or, in other words, in) the first area. A second plurality of replicas of (or, in other words, according to) the second image form (or, in other words, are output/emitted from) a second light footprint on (or, in other words, in) the second area. The first and second areas are spatial separate. That is, the first and second areas are located on the light control device such that there is no overlap between them (when looking in a direction orthogonal to the output surface of the replicator). In other words, the first area may be spaced from the second area. The first and second areas may be abutting or may be separated by a gap therebetween. The display system further comprises a driver arranged to move the light control device relative to the replicator (in other words, relative to the viewing window). The driver may be a servo, actuator or any other device suitable for providing the required motion. The motion may be described as being between a first and a second position. The motion may be linear or non-linear, that is in one dimension or in two dimensions, as will be described further below.

In this way, a dual-plane (or, more generally, a multi-plane) display system is provided in a two-step solution. Firstly, by spatially separating the first and second areas, there is no interference between the first and second plurality of replicas and so the images on the first and second plane can both be formed correctly. Furthermore, each area of the light control device only has to correct for a single (virtual) image distance, simplifying the design of said light control device. However, this provides the further problem of effectively reducing the size of the viewing window (due to the reduced size of the areas emitting the display light replicas). This would mean that the range of movement afforded to the user would be greatly reduced before the quality of the images dropped. A larger replicator and light control device could be used to compensate for this (i.e. a light control device large enough that overlap of the areas of the light control device does not need to arise without reducing the size of said areas), but this would increase the size of the system which, as described above, is undesirable for automotive applications. Instead, the light control device is arranged such that it is moved. The movement of the light control device therefore moves the first and second areas therefore can adjust to provide the best quality images throughout the viewing window. The sufficiently high image quality required can therefore be provided to the user regardless of their position within the viewing window and therefore a dual-plane (or multi-plane) display system is provided.

In other words, the light control device is designed such that it can be moved as the user moves their head. In this way, the user is always looking through the same part of the light control device for all positions in (or relative to) the viewing window. This removes the difficulty of having regions of the light control device struggle to support multiple virtual image distances. As such, in summary the display system of this first aspect provides a reduction in head-up display package volume by converting freeform reflective mirrors to a more compact light control device, which may be a freeform Fresnel-type structure (e.g. comprising a so-called wrapped physical configuration), whilst translation of the light control device ensures correct depths of the displayed images are perceived for all positions in the viewing window.

The display system may further comprise a non-uniform (e.g. curved) optical component (located) downstream from the light control device. That is, the non-uniform optical component is located on an optical path between the light control device and the viewing window. The light control device may therefore be used to relay the replicas from the light control device to the viewing window. The light control device may be arranged to compensate for the non-uniformity of the non-uniform optical component (e.g. the curvature of a curved optical component). That is, any optical distortion imparted upon the replicas by the non-uniform optical component is compensated for by the light control device. In other words, the replicas are pre-distorted by the light control device to counteract any distortion imparted upon them by the non-uniform optical component. The non-uniform optical component may be an optical combiner, such as a vehicle windscreen.

Moving the light control device to enable the dual/multi-plane display, as described above, means that the location on the non-uniform optical component from which the replicas are reflected/relayed towards the viewing window may change. As the non-uniform optical component may require a different compensation at every point across its surface, moving the light control device as described above may result in the light control device having a reduced compensatory effect (as the compensation of the moving light control device is fixed). However, the inventors have surprisingly found that any increase in distortions caused by the reduction in compensatory effect is outweighed by the advantages of the moving light control device discussed above (that is, the ability to provide a dual/multi-plane display device).

The light control device may further mitigate glare as described above. That is, the output surface of the replicator may be a (at least partially) reflective surface arranged, during operation of the display system, in a configuration that is conducive to sunlight glare. That is, the output surface may be arranged when the display system is being used such that could reflect sunlight. That is not to say that the output surface in this case is only reflective to sunlight in this location, merely that it is situated in a position that is exposed to sunlight. The light control device may be arranged to receive (or intercept) sunlight on an optical path to the viewing window. The light control device may be configured to attenuate sunlight, such as absorb sunlight. As such, the light control device acts to prevent sunlight glare from the replicator reaching the viewing window. As such, along with the non-uniform optical component compensation function described above, the light control device may be referred to as a corrective glare mitigation device.

An optical power of the light control device may be associated with an average position of a user relative to (in other words, within) the viewing window. By average position it is meant the position most often/frequently occupied by the user during use of the display system. Alternatively, an optical power of the non-uniform optical component may be associated with the centre of the viewing window. By the centre of the viewing window it is meant the midpoint of the viewing window in a plane orthogonal to the replicas as they arrive at the viewing window. That is, the light control device may be designed in a way such that an optical power used for the aforementioned compensation is based on the viewing window and a user's position within it. In other words, the optical power being associated with positions of the user means that each user position corresponds to a sub-area of the windscreen or to a first/second sub-area for the first/second (virtual) images. In this way, the above-mentioned reduction in compensatory effect can be mitigated as much as possible by using an optical power that will never be drastically different from the optical power that would have been required for each point of the light control device in display systems according to the prior art (i.e. in a display system with a static light control device).

The light control device may have optical power substantially inverse to that of the non-uniform optical component. By substantially inverse it is meant that, as described above, any distortions caused by the non-uniform optical component are compensated for by the light control device. In other words, the optical power of the light control device and the optical power of the non-uniform optical component have a product of one, or as close to one as to provide a satisfactorily low level of optical distortion.

The first plane may be spatial separate from the second plane in a direction parallel to optical path of the replicas from the non-uniform optical component to the viewing window. In other words, the direction substantially normal to the viewing window. That is, the display system may have first image distance from the viewing window to the first plane and a second image distance from the viewing window to the second plane, the first and second image distances being unequal. These distances may be taken along a plane parallel to the output surface of the replicator. As such, it is further clarified that the display system according to this first aspect is a dual-plane (or, more broadly, a multi-plane) display device. The first and second images may be different. That is, the first and second images may have different image content specifically chosen depending on which plane of the display system they are to be displayed on. For example, the image to be displayed on a near plane may have image content relating to vehicle information (such as vehicle speed and range), whilst the image to be displayed on a far plane may have image content relating to hazard and environmental warnings.

The movement of the light control device may be on a plane parallel to a plane of the output surface of the replicator (or, in other words, substantially normal to the viewing window). In other words, the light control device may move parallel to the (output surface of) the replicator. The movement of the light control device may have a component in a direction parallel to optical path of the replicas from the non-uniform optical component to the viewing window. In other words, the light control may move towards and further away from the viewing window (and therefore the user). As the dual- or multi-plane content is envisaged as typically being staggered in depth vertically (from the perspective of the user), regions where the light control device would have to support multiple viewing depths is most pronounced vertically, hence the motion vertically with respect to the viewpoint of the user (i.e. movement towards and away from the user). However, embodiments with a component of movement perpendicular to this movement is also envisaged.

The (maximum extent of the possible) movement of the light control device may be between a first position and a second position. The first position may be such that the replicas are relayed to proximate a first edge of the viewing window and the second position being such that the replicas are relayed to proximate a second edge of the viewing window. The first edge of the viewing window is arranged opposite the second edge. As such, the system can provide high quality images through the full range of the viewing window.

The display system may further comprise an eye-tracking system arranged to track the position of at least one of a user's eyes relative to the viewing window. More broadly, the display system may further comprise a user-tracking system arranged to track the position of a user relative to (in other words, within) the viewing window. The movement (in other words, the position) of the light control device may dependent on said position. In other words, an eye-tracking system can be used to determine where the user is relative to the viewing window (that is, find the footprint their eye would have on the replicator if tracing light rays from the user's eyes to the replicator), while the light control device is moved accordingly to align with the user's eye footprint on the replicator. In this way, the light control device can be adjusted according to the position of the user during use of the display system, ensuring that at all times the user can perceive the images displayed at multiple depths.

The position (in other words, the movement) of the light control device may be dependent on user position data received by the driver. The user position data may be seat position or height of the user. In this way, the position of the user can be used to calculate the necessary movement of the user to adjust the position of the light control device to align with the user's eye footprint on the replicator. This can be done during the start-up of the display device. It can either be used as a good starting point for the eye-tracking system, or used on its own to reduce the complexity of the system. This assumes that the user is not anticipated to move from this initial position much, or at all, during use, or that any slight movements will have minimal impact on the image quality perceived.

In a second aspect, a method of (operating a) head-up display is provided. The method is to projecting (in other words, displaying) a first image on (or at) a first plane and projecting (in other words, displaying) a second image on (or at) a second plane. The method comprises a step of replicating, via a replicator, spatially modulated light corresponding to the first image and the second image to form a plurality of replicas of the spatially modulated light by waveguiding between a reflective surface and a transmissive-reflective surface. The method comprises a step of illuminating a light control device with the replicas of the spatially modulated light corresponding to the first image and the second image. A first plurality of replicas of the first image forms a first footprint on a first area of the light control device. A second plurality of replicas of the second image forms a second light footprint on a second area of the light control device. The first and second areas are spatially separated. The method further comprises a step of relaying (in other words reflecting) the replicas of the spatially modulated light corresponding to the first and second images to a viewing window (in other words, an eye-box of a user/viewer) using a non-uniform optical component having non-uniform optical power. The non-uniform optical component may be an optical combiner, for example a windscreen. The method further comprises a step of moving the light control device relative to the replicator (in other words, the viewing window or user). This movement step may be before or after the steps of illuminating the light control device and the step of replating the first and second images to the viewing window, as will be described further below. The movement may be described as being between a first and a second position. As described above, the movement may be achieved using a driver. The movement may be such that the positions of the first and second areas on the light control device are maintained for a plurality of viewing positions of the viewing window, optionally all viewing positions of the viewing window. In this way, as described above, a method for the display of dual-plane (or, more broadly, multi-plane) images is provided.

The method may further comprise a first movement step of moving the light control device that occurs before the step of illuminating the light control device. The method may further comprise receiving user positioning data. The movement of the light control device in the first movement step may be dependent on said data.

The method may further comprise a second step of moving the light control device that occurs after the step of relaying the replicas of the spatially modulated light corresponding to the first and second images to the viewing window. The method may further comprise receiving data from an eye-tracking system arranged to track the position of at least one of a user's eyes relative to the viewing window. The movement of the light control device in the second movement step may be dependent on said position.

In a third aspect, a method of head-up display is provided. The method is to projecting a first image on a first plane and may further be to projecting a second image on a second plane. The method comprises a step of illuminating a light control device with light corresponding to the first image. The light of the first image forms a first footprint on a first area of the light control device. The method further comprises a step of relaying the first image to a viewing window using a non-uniform optical component having non-uniform optical power. The method further comprises a step of moving the light control device relative to the replicator. The movement is such that the first area (which can also be referred to as an active area) of the light control device is constant (in other words, fixed or non-changing with regards to its position on the light control device). By active area, it is meant the area of the light control device from which image(s) are relayed to the user within the viewing window. In this way, as described above, a method for the display of dual-plane (or, more broadly, multi-plane) images is provided.

In a fourth aspect and more broadly, a display system is provided, the display system having a viewing window. The display system comprises a replicator arranged to receive spatially modulated light and replicate the spatially modulated light to form a plurality of replicas of the spatially modulated light. The replicator achieves this by waveguiding the spatially modulated light between a reflective surface and a transmissive-reflective surface. The transmissive-reflective surface forms an output surface for the plurality of replicas of the spatially modulated light. The display system further comprises a light control device located in the optical path of the plurality of replicas of the spatially modulated light downstream from the output surface of the replicator. The light control device is arranged to compensate for the curvature of a non-uniform (curved) optical component downstream from the light control device. The display system further comprises a driver arranged to move the light control device (between a first position and a second position), wherein the movement corresponds to the movement of a user relative to (in other words, within) the viewing window.

Feature and advantages described in relation to the first aspect may apply to the methods of the second and third aspects and the system of the fourth aspect, and vice versa.

In the present disclosure, the term “replica” is merely used to reflect that spatially modulated light is divided such that a complex light field is directed along a plurality of different optical paths. The word “replica” is used to refer to each occurrence or instance of the complex light field after a replication event—such as a partial reflection-transmission by a pupil expander. Each replica travels along a different optical path. Some embodiments of the present disclosure relate to propagation of light that is encoded with a hologram, not an image—i.e., light that is spatially modulated with a hologram of an image, not the image itself. It may therefore be said that a plurality of replicas of the hologram are formed. The person skilled in the art of holography will appreciate that the complex light field associated with propagation of light encoded with a hologram will change with propagation distance. Use herein of the term “replica” is independent of propagation distance and so the two branches or paths of light associated with a replication event are still referred to as “replicas” of each other even if the branches are a different length, such that the complex light field has evolved differently along each path. That is, two complex light fields are still considered “replicas” in accordance with this disclosure even if they are associated with different propagation distances-providing they have arisen from the same replication event or series of replication events.

A “diffracted light field” or “diffractive light field” in accordance with this disclosure is a light field formed by diffraction. A diffracted light field may be formed by illuminating a corresponding diffractive pattern. In accordance with this disclosure, an example of a diffractive pattern is a hologram and an example of a diffracted light field is a holographic light field or a light field forming a holographic reconstruction of an image. The holographic light field forms a (holographic) reconstruction of an image on a replay plane. The holographic light field that propagates from the hologram to the replay plane may be said to comprise light encoded with the hologram or light in the hologram domain. A diffracted light field is characterized by a diffraction angle determined by the smallest feature size of the diffractive structure and the wavelength of the light (of the diffracted light field). In accordance with this disclosure, it may also be said that a “diffracted light field” is a light field that forms a reconstruction on a plane spatially separated from the corresponding diffractive structure. An optical system is disclosed herein for propagating a diffracted light field from a diffractive structure to a viewer. The diffracted light field may form an image.

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2 shows an image for projection comprising eight image areas/components, V1 to V8, and cross-sections of the corresponding hologram channels, H1-H8;

FIG. 3 shows a hologram displayed on an LCOS that directs light into a plurality of discrete areas;

FIG. 4 shows a system, including a display device that displays a hologram that has been calculated as illustrated in FIGS. 2 and 3;

FIG. 5A shows a perspective view of a first example two-dimensional pupil expander comprising two replicators each comprising pairs of stacked surfaces;

FIG. 5B shows a perspective view of a first example two-dimensional pupil expander comprising two replicators each in the form of a solid waveguide;

FIG. 6 is a schematic side view of a display device in accordance with the prior art;

FIG. 7 is an enlarged partial view of the display device of FIG. 6;

FIG. 8 is a schematic side view of a display device in accordance with the present disclosure in a first position;

FIG. 9 is an enlarged partial view of the display device of FIG. 8;

FIG. 10 is a schematic side view of the display device of FIG. 8 in a second position;

FIG. 11 is an enlarged partial view of the display device of FIG. 10;

FIG. 12 shows a graphical representation of a footprint of a waveguide for a position of a user/viewer at the top of an eye-box/viewing window;

FIG. 13 shows a graphical representation of a footprint of a waveguide for a position of a user/viewer in the middle of an eye-box/viewing window;

FIG. 14 shows a graphical representation of a footprint of a waveguide for a position of a user/viewer at the bottom of an eye-box/viewing window;

FIG. 15 shows a graphical representation of the footprints of FIGS. 12, 13 and 14 on a waveguide when viewed along a plane orthogonal to an output surface of the waveguide; and

FIG. 16 shows a sum of the footprints of FIG. 15.

The same reference numbers will be used throughout the drawings to refer to the same or like parts.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise. A structure described as being formed at an upper portion/lower portion of another structure or on/under the other structure should be construed as including a case where the structures contact each other and, moreover, a case where a third structure is disposed there between.

In describing a time relationship—for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

In the present disclosure, the term “substantially” when applied to a structural units of an apparatus may be interpreted as the technical feature of the structural units being produced within the technical tolerance of the method used to manufacture it.

### Conventional Optical Configuration for Holographic Projection

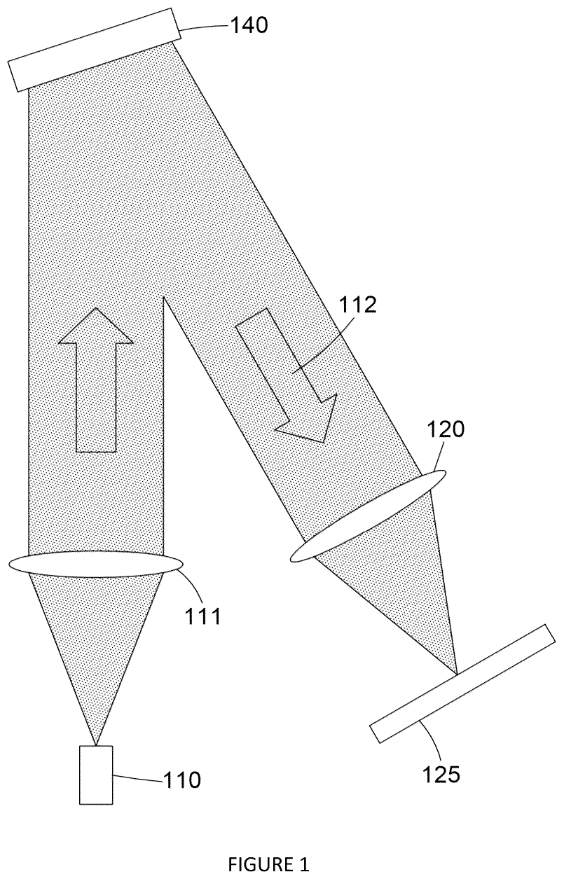

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform In some embodiments of the present disclosure, the lens of the viewer's eye performs the hologram to image transformation.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms. Embodiments relate to Fourier holography and Gerchberg-Saxton type algorithms by way of example only. The present disclosure is equally applicable to Fresnel holography and Fresnel holograms which may be calculated by a similar method. In some embodiments, the hologram is a phase or phase-only hologram. However, the present disclosure is also applicable to holograms calculated by other techniques such as those based on point cloud methods.

In some embodiments, the hologram engine is arranged to exclude from the hologram calculation the contribution of light blocked by a limiting aperture of the display system. British patent application 2101666.2, filed 5 Feb. 2021 and incorporated herein by reference, discloses a first hologram calculation method in which eye-tracking and ray tracing are used to identify a sub-area of the display device for calculation of a point cloud hologram which eliminates ghost images. The sub-area of the display device corresponds with the aperture, of the present disclosure, and is used exclude light paths from the hologram calculation. British patent application 2112213.0, filed 26 Aug. 2021 and incorporated herein by reference, discloses a second method based on a modified Gerchberg-Saxton type algorithm which includes steps of light field cropping in accordance with pupils of the optical system during hologram calculation. The cropping of the light field corresponds with the determination of a limiting aperture of the present disclosure. British patent application 2118911.3, filed 23 Dec. 2021 and also incorporated herein by reference, discloses a third method of calculating a hologram which includes a step of determining a region of a so-called extended modulator formed by a hologram replicator. The region of the extended modulator is also an aperture in accordance with this disclosure.

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

### Large Field of View Using Small Display Device

Broadly, the present disclosure relates to image projection. It relates to a method of image projection and an image projector which comprises a display device. The present disclosure also relates to a projection system comprising the image projector and a viewing system, in which the image projector projects or relays light from the display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other examples, the image is a real image formed by holographic reconstruction and the image is projected or relayed to the viewing plane. In these other examples, spatially modulated light of an intermediate holographic reconstruction formed either in free space or on a screen or other light receiving surface between the display device and the viewer, is propagated to the viewer. In both cases, an image is formed by illuminating a diffractive pattern (e.g., hologram or kinoform) displayed on the display device.

The display device comprises pixels. The pixels of the display may display a diffractive pattern or structure that diffracts light. The diffracted light may form an image at a plane spatially separated from the display device. In accordance with well-understood optics, the magnitude of the maximum diffraction angle is determined by the size of the pixels and other factors such as the wavelength of the light.

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some embodiments, the (light of a) hologram itself is propagated to the eyes. For example, spatially modulated light of the hologram (that has not yet been fully transformed to a holographic reconstruction, i.e. image)—that may be informally said to be “encoded” with/by the hologram—is propagated directly to the viewer's eyes. A real or virtual image may be perceived by the viewer. In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

Reference is made herein to a “light field” which is a “complex light field”. The term “light field” merely indicates a pattern of light having a finite size in at least two orthogonal spatial directions, e.g. x and y. The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field.

In accordance with the principles of well-understood optics, the range of angles of light propagating from a display device that can be viewed, by an eye or other viewing entity/system, varies with the distance between the display device and the viewing entity. At a 1 metre viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g., any one eye position within a viewing window such as eye-box.)

In some embodiments, the image perceived by a viewer is a virtual image that appears upstream of the display device—that is, the viewer perceives the image as being further away from them than the display device. Conceptually, it may therefore be considered that the viewer is looking at a virtual image through an ‘display device-sized window’, which may be very small, for example 1 cm in diameter, at a relatively large distance, e.g., 1 metre. And the user will be viewing the display device-sized window via the pupil(s) of their eye(s), which can also be very small. Accordingly, the field of view becomes small and the specific angular range that can be seen depends heavily on the eye position, at any given time.

A pupil expander addresses the problem of how to increase the range of angles of light rays that are propagated from the display device that can successfully propagate through an eye's pupil to form an image. The display device is generally (in relative terms) small and the projection distance is (in relative terms) large. In some embodiments, the projection distance is at least one-such as, at least two-orders of magnitude greater than the diameter, or width, of the entrance pupil and/or aperture of the display device (i.e., size of the array of pixels).

Use of a pupil expander increases the viewing area (i.e., user's eye-box) laterally, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure encompasses non-infinite virtual image distances—that is, near-field virtual images.

Conventionally, a two-dimensional pupil expander comprises one or more one-dimensional optical waveguides each formed using a pair of opposing reflective surfaces, in which the output light from a surface forms a viewing window or eye-box. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront.

The display device may have an active or display area having a first dimension that may be less than 10 cms such as less than 5 cms or less than 2 cms. The propagation distance between the display device and viewing system may be greater than 1 m such as greater than 1.5 m or greater than 2 m. The optical propagation distance within the waveguide may be up to 2 m such as up to 1.5 m or up to 1 m. The method may be capable of receiving an image and determining a corresponding hologram of sufficient quality in less than 20 ms such as less than 15 ms or less than 10 ms.

In some embodiments-described only by way of example of a diffracted or holographic light field in accordance with this disclosure-a hologram is configured to route light into a plurality of channels, each channel corresponding to a different part (i.e. sub-area) of an image. The channels formed by the diffractive structure are referred to herein as “hologram channels” merely to reflect that they are channels of light encoded by the hologram with image information. It may be said that the light of each channel is in the hologram domain rather than the image or spatial domain. In some embodiments, the hologram is a Fourier or Fourier transform hologram and the hologram domain is therefore the Fourier or frequency domain. The hologram may equally be a Fresnel or Fresnel transform hologram. The hologram may also be a point cloud hologram. The hologram is described herein as routing light into a plurality of hologram channels to reflect that the image that can be reconstructed from the hologram has a finite size and can be arbitrarily divided into a plurality of image sub-areas, wherein each hologram channel would correspond to each image sub-area. Importantly, the hologram of this example is characterised by how it distributes the image content when illuminated. Specifically and uniquely, the hologram divides the image content by angle. That is, each point on the image is associated with a unique light ray angle in the spatially modulated light formed by the hologram when illuminated—at least, a unique pair of angles because the hologram is two-dimensional. For the avoidance of doubt, this hologram behaviour is not conventional. The spatially modulated light formed by this special type of hologram, when illuminated, may be divided into a plurality of hologram channels, wherein each hologram channel is defined by a range of light ray angles (in two-dimensions). It will be understood from the foregoing that any hologram channel (i.e. sub-range of light ray angles) that may be considered in the spatially modulated light will be associated with a respective part or sub-area of the image. That is, all the information needed to reconstruct that part or sub-area of the image is contained within a sub-range of angles of the spatially modulated light formed from the hologram of the image. When the spatially modulated light is observed as a whole, there is not necessarily any evidence of a plurality of discrete light channels.

Nevertheless, the hologram may still be identified. For example, if only a continuous part or sub-area of the spatially modulated light formed by the hologram is reconstructed, only a sub-area of the image should be visible. If a different, continuous part or sub-area of the spatially modulated light is reconstructed, a different sub-area of the image should be visible. A further identifying feature of this type of hologram is that the shape of the cross-sectional area of any hologram channel substantially corresponds to (i.e. is substantially the same as) the shape of the entrance pupil although the size may be different—at least, at the correct plane for which the hologram was calculated. Each light/hologram channel propagates from the hologram at a different angle or range of angles. Whilst these are example ways of characterising or identifying this type of hologram, other ways may be used. In summary, the hologram disclosed herein is characterised and identifiable by how the image content is distributed within light encoded by the hologram. Again, for the avoidance of any doubt, reference herein to a hologram configured to direct light or angularly-divide an image into a plurality of hologram channels is made by way of example only and the present disclosure is equally applicable to pupil expansion of any type of holographic light field or even any type of diffractive or diffracted light field.

The system can be provided in a compact and streamlined physical form. This enables the system to be suitable for a broad range of real-world applications, including those for which space is limited and real-estate value is high. For example, it may be implemented in a head-up display (HUD) such as a vehicle or automotive HUD.

In accordance with the present disclosure, pupil expansion is provided for diffracted or diffractive light, which may comprise diverging ray bundles. The diffracted light field may be defined by a “light cone”. Thus, the size of the diffracted light field (as defined on a two-dimensional plane) increases with propagation distance from the corresponding diffractive structure (i.e. display device). It can be said that the pupil expander/s replicate the hologram or form at least one replica of the hologram, to convey that the light delivered to the viewer is spatially modulated in accordance with a hologram.

In some embodiments, two one-dimensional waveguide pupil expanders are provided, each one-dimensional waveguide pupil expander being arranged to effectively increase the size of the exit pupil of the system by forming a plurality of replicas or copies of the exit pupil (or light of the exit pupil) of the spatial light modulator. The exit pupil may be understood to be the physical area from which light is output by the system. It may also be said that each waveguide pupil expander is arranged to expand the size of the exit pupil of the system. It may also be said that each waveguide pupil expander is arranged to expand/increase the size of the eye box within which a viewer's eye can be located, in order to see/receive light that is output by the system.

### Light Channelling

The hologram formed in accordance with some embodiments, angularly-divides the image content to provide a plurality of hologram channels which may have a cross-sectional shape defined by an aperture of the optical system. The hologram is calculated to provide this channelling of the diffracted light field. In some embodiments, this is achieved during hologram calculation by considering an aperture (virtual or real) of the optical system, as described above.

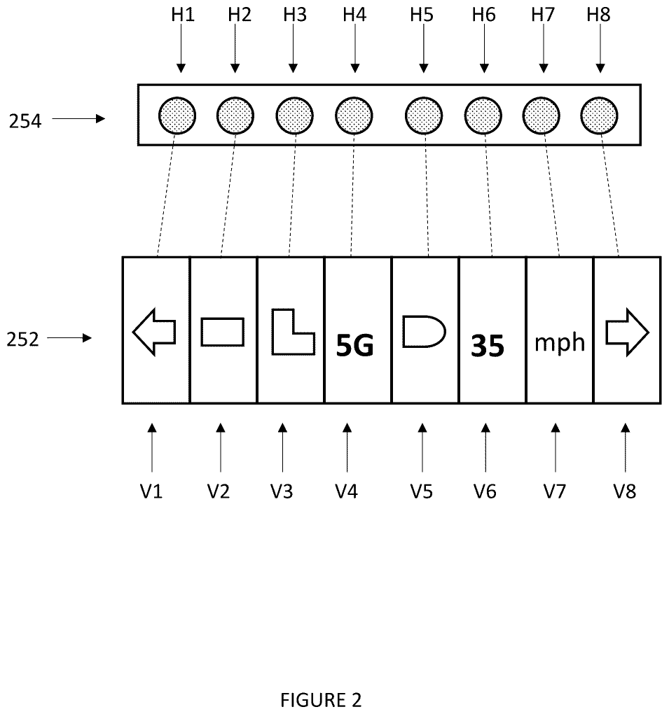

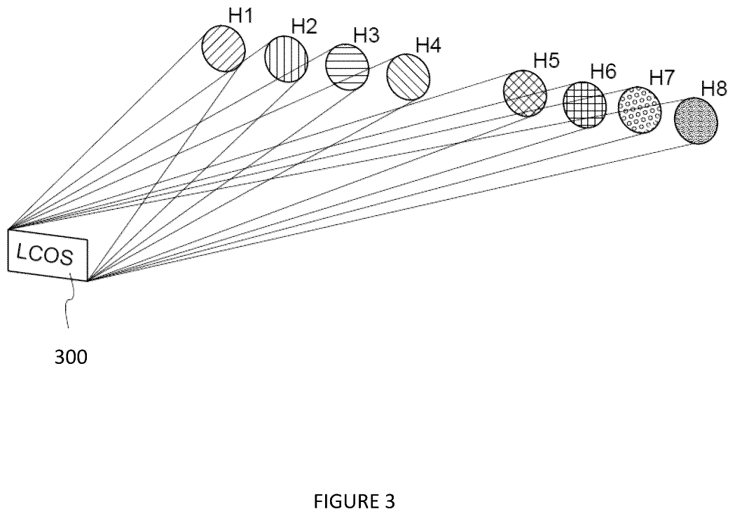

FIGS. 2 and 3 show an example of this type of hologram that may be used in conjunction with a pupil expander as disclosed herein. However, this example should not be regarded as limiting with respect to the present disclosure.

FIG. 2 shows an image 252 for projection comprising eight image areas/components, V1 to V8. FIG. 2 shows eight image components by way of example only and the image 252 may be divided into any number of components. FIG. 2 also shows an encoded light pattern 254 (i.e., hologram) that can reconstruct the image 252—e.g., when transformed by the lens of a suitable viewing system. The encoded light pattern 254 comprises first to eighth sub-holograms or components, H1 to H8, corresponding to the first to eighth image components/areas, V1 to V8. FIG. 2 further shows how a hologram may decompose the image content by angle. The hologram may therefore be characterised by the channelling of light that it performs. This is illustrated in FIG. 3. Specifically, the hologram in this example directs light into a plurality of discrete areas. The discrete areas are discs in the example shown but other shapes are envisaged. The size and shape of the optimum disc may, after propagation through the waveguide, be related to the size and shape of an aperture of the optical system such as the entrance pupil of the viewing system.

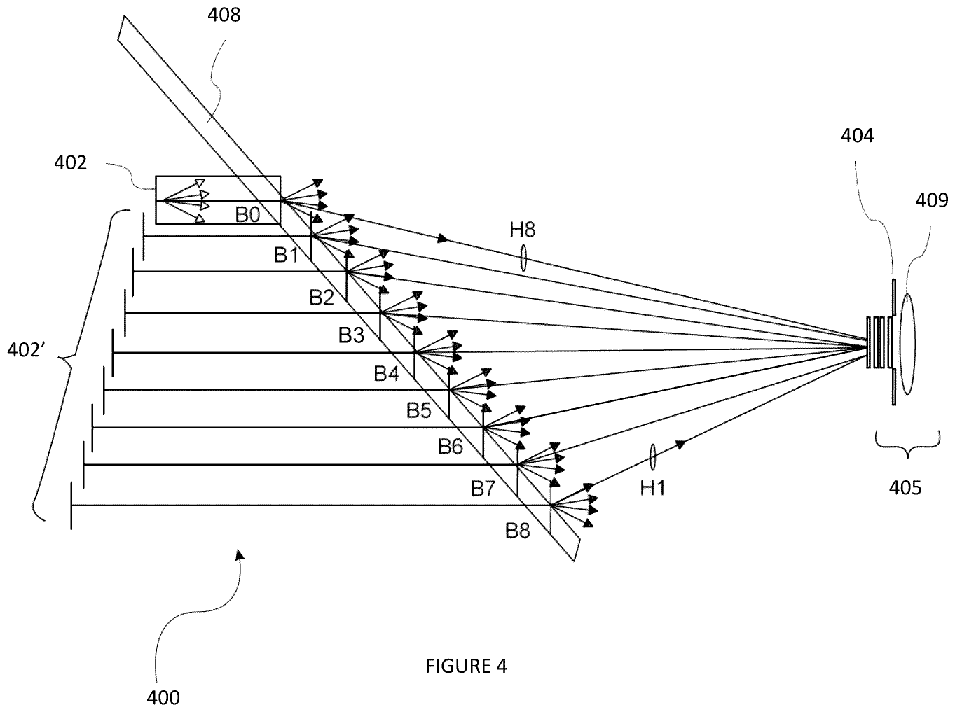

FIG. 4 shows a system 400, including a display device that displays a hologram that has been calculated as illustrated in FIGS. 2 and 3.

The system 400 comprises a display device, which in this arrangement comprises an LCOS 402. The LCOS 402 is arranged to display a modulation pattern (or ‘diffractive pattern’) comprising the hologram and to project light that has been holographically encoded towards an eye 405 that comprises a pupil that acts as an aperture 404, a lens 409, and a retina (not shown) that acts as a viewing plane. There is a light source (not shown) arranged to illuminate the LCOS 402. The lens 409 of the eye 405 performs a hologram-to-image transformation. The light source may be of any suitable type. For example, it may comprise a laser light source.

The viewing system 400 further comprises a waveguide 408 positioned between the LCOS 402 and the eye 405. The presence of the waveguide 408 enables all angular content from the LCOS 402 to be received by the eye, even at the relatively large projection distance shown. This is because the waveguide 508 acts as a pupil expander, in a manner that is well known and so is described only briefly herein.

In brief, the waveguide 408 shown in FIG. 4 comprises a substantially elongate formation. In this example, the waveguide 408 comprises an optical slab of refractive material, but other types of waveguide are also well known and may be used. The waveguide 408 is located so as to intersect the light cone (i.e., the diffracted light field) that is projected from the LCOS 402, for example at an oblique angle. In this example, the size, location, and position of the waveguide 408 are configured to ensure that light from each of the eight ray bundles, within the light cone, enters the waveguide 408. Light from the light cone enters the waveguide 408 via its first planar surface (located nearest the LCOS 402) and is guided at least partially along the length of the waveguide 408, before being emitted via its second planar surface, substantially opposite the first surface (located nearest the eye). As will be well understood, the second planar surface is partially reflective, partially transmissive. In other words, when each ray of light travels within the waveguide 408 from the first planar surface and hits the second planar surface, some of the light will be transmitted out of the waveguide 408 and some will be reflected by the second planar surface, back towards the first planar surface. The first planar surface is reflective, such that all light that hits it, from within the waveguide 408, will be reflected back towards the second planar surface. Therefore, some of the light may simply be refracted between the two planar surfaces of the waveguide 408 before being transmitted, whilst other light may be reflected, and thus may undergo one or more reflections, (or ‘bounces’) between the planar surfaces of the waveguide 408, before being transmitted.

FIG. 4 shows a total of nine “bounce” points, B0 to B8, along the length of the waveguide 408. Although light relating to all points of the image (V1-V8) as shown in FIG. 2 is transmitted out of the waveguide at each “bounce” from the second planar surface of the waveguide 408, only the light from one angular part of the image (e.g. light of one of V1 to V8) has a trajectory that enables it to reach the eye 405, from each respective “bounce” point, B0 to B8. Moreover, light from a different angular part of the image, V1 to V8, reaches the eye 405 from each respective “bounce” point. Therefore, each angular channel of encoded light reaches the eye only once, from the waveguide 408, in the example of FIG. 4.

The waveguide 408 forms a plurality of replicas of the hologram, at the respective “bounce” points B1 to B8 along its length, corresponding to the direction of pupil expansion. As shown in FIG. 4, the plurality of replicas may be extrapolated back, in a straight line, to a corresponding plurality of replica or virtual display devices 402′. This process corresponds to the step of “unfolding” an optical path within the waveguide, so that a light ray of a replica is extrapolated back to a “virtual surface” without internal reflection within the waveguide. Thus, the light of the expanded exit pupil may be considered to originate from a virtual surface (also called an “extended modulator” herein) comprising the display device 402 and the replica display devices 402′.

Although virtual images, which require the eye to transform received modulated light in order to form a perceived image, have generally been discussed herein, the methods and arrangements described herein can be applied to real images.

### Two-Dimensional Pupil Expansion

Whilst the arrangement shown in FIG. 4 includes a single waveguide that provides pupil expansion in one dimension, pupil expansion can be provided in more than one dimension, for example in two dimensions. Moreover, whilst the example in FIG. 4 uses a hologram that has been calculated to create channels of light, each corresponding to a different portion of an image, the present disclosure and the systems that are described herebelow are not limited to such a hologram type.

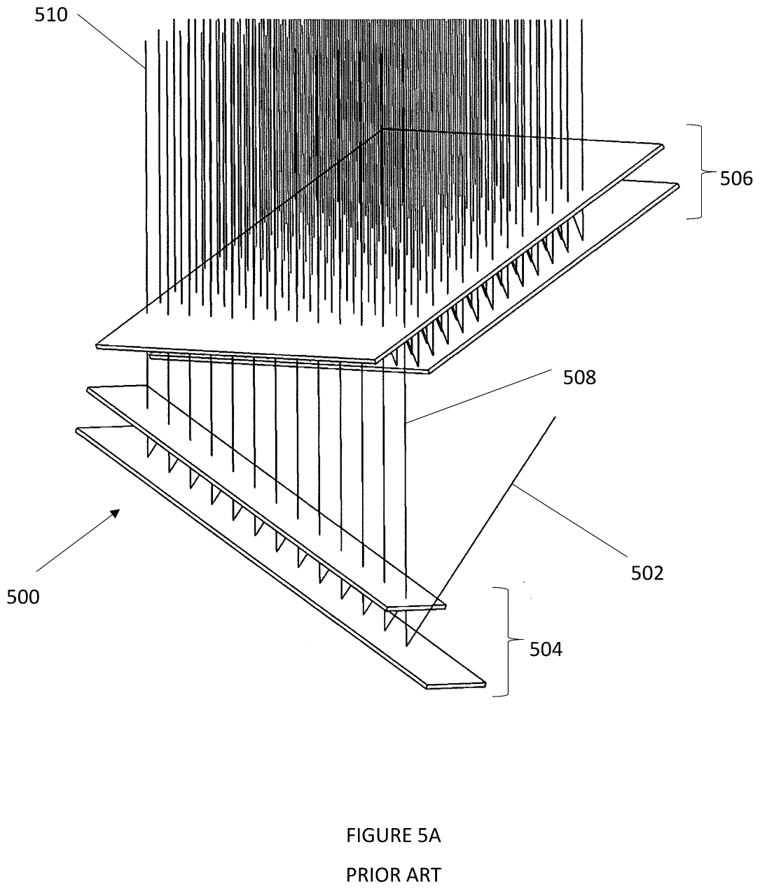

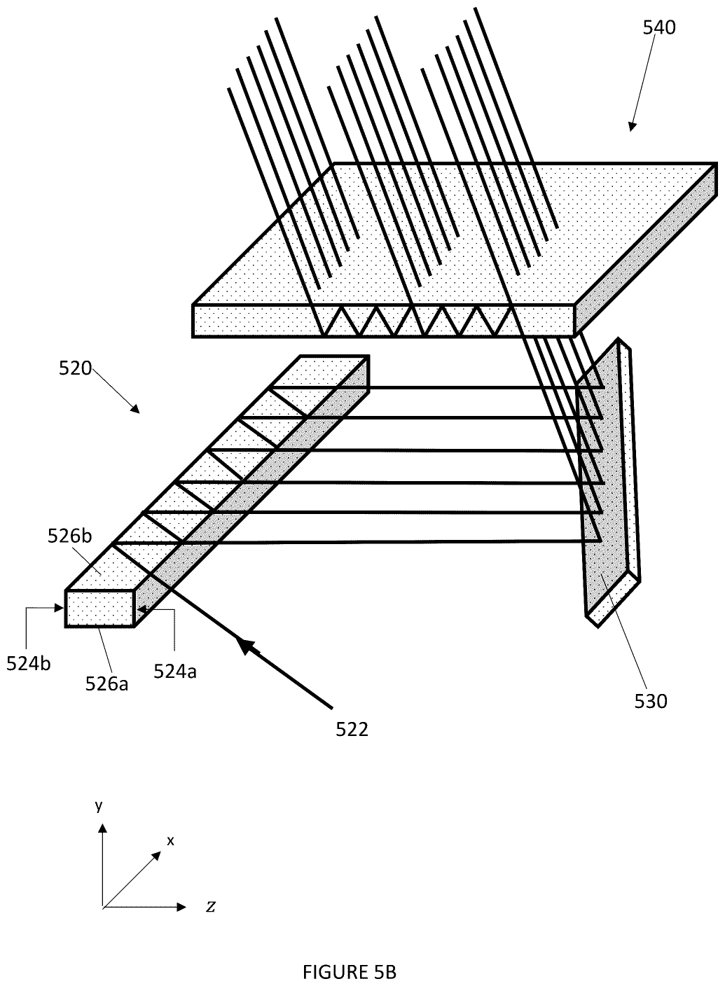

FIG. 5A shows a perspective view of a system 500 comprising two replicators, 504, 506 arranged for expanding a light beam 502 in two dimensions.

In the system 500 of FIG. 5A, the first replicator 504 comprises a first pair of surfaces, stacked parallel to one another, and arranged to provide replication—or, pupil expansion—in a similar manner to the waveguide 408 of FIG. 4. The first pair of surfaces are similarly (in some cases, identically) sized and shaped to one another and are substantially elongate in one direction. The collimated light beam 502 is directed towards an input on the first replicator 504. Due to a process of internal reflection between the two surfaces, and partial transmission of light from each of a plurality of output points on one of the surfaces (the upper surface, as shown in FIG. 5A), which will be familiar to the skilled reader, light of the light beam 502 is replicated in a first direction, along the length of the first replicator 504. Thus, a first plurality of replica light beams 508 is emitted from the first replicator 504, towards the second replicator 506.

The second replicator 506 comprises a second pair of surfaces stacked parallel to one another, arranged to receive each of the collimated light beams of the first plurality of light beams 508 and further arranged to provide replication—or, pupil expansion—by expanding each of those light beams in a second direction, substantially orthogonal to the first direction. The first pair of surfaces are similarly (in some cases, identically) sized and shaped to one another and are substantially rectangular. The rectangular shape is implemented for the second replicator in order for it to have length along the first direction, in order to receive the first plurality of light beams 508, and to have length along the second, orthogonal direction, in order to provide replication in that second direction. Due to a process of internal reflection between the two surfaces, and partial transmission of light from each of a plurality of output points on one of the surfaces (the upper surface, as shown in FIG. 5A), light of each light beam within the first plurality of light beams 508 is replicated in the second direction. Thus, a second plurality of light beams 510 is emitted from the second replicator 506, wherein the second plurality of light beams 510 comprises replicas of the input light beam 502 along each of the first direction and the second direction. Thus, the second plurality of light beams 510 may be regarded as comprising a two-dimensional grid, or array, of replica light beams.

Thus, it can be said that the first and second replicators 504, 505 of FIG. 5A combine to provide a two-dimensional replicator (or, “two-dimensional pupil expander”). Thus, the replica light beams 510 may be emitted along an optical path to an expanded eye-box of a display system, such as a head-up display.

In the system of FIG. 5A, the first replicator 504 is a waveguide comprising a pair of elongate rectilinear reflective surfaces, stacked parallel to one another, and, similarly, the second replicator 504 is a waveguide comprising a pair of rectangular reflective surfaces, stacked parallel to one another. In other systems, the first replicator may be a solid elongate rectilinear waveguide and the second replicator may be a solid planar rectangular shaped waveguide, wherein each waveguide comprises an optically transparent solid material such as glass. In this case, the pair of parallel reflective surfaces are formed by a pair of opposed major sidewalls optionally comprising respective reflective and reflective-transmissive surface coatings, familiar to the skilled reader.

FIG. 5B shows a perspective view of a system 500 comprising two replicators, 520, 540 arranged for replicating a light beam 522 in two dimensions, in which the first replicator is a solid elongated waveguide 520 and the second replicator is a solid planar waveguide 540.

In the system of FIG. 5B, the first replicator/waveguide 520 is arranged so that its pair of elongate parallel reflective surfaces 524a, 524b are perpendicular to the plane of the second replicator/waveguide 540. Accordingly, the system comprises an optical coupler arranged to couple light from an output port of first replicator 520 into an input port of the second replicator 540. In the illustrated arrangement, the optical coupler is a planar/fold mirror 530 arranged to fold or turn the optical path of light to achieve the required optical coupling from the first replicator to the second replicator. As shown in FIG. 5B, the mirror 530 is arranged to receive light-comprising a one-dimensional array of replicas extending in the first dimension—from the output port/reflective-transmissive surface 524a of the first replicator/waveguide 520. The mirror 530 is tilted so as to redirect the received light onto an optical path to an input port in the (fully) reflective surface of second replicator 540 at an angle to provide waveguiding and replica formation, along its length in the second dimension. It will be appreciated that the mirror 530 is one example of an optical element that can redirect the light in the manner shown, and that one or more other elements may be used instead, to perform this task.

In the illustrated arrangement, the (partially) reflective-transmissive surface 524a of the first replicator 520 is adjacent the input port of the first replicator/waveguide 520 that receives input beam 522 at an angle to provide waveguiding and replica formation, along its length in the first dimension. Thus, the input port of first replicator/waveguide 520 is positioned at an input end thereof at the same surface as the reflective-transmissive surface 524a. The skilled reader will understand that the input port of the first replicator/waveguide 520 may be at any other suitable position.

Accordingly, the arrangement of FIG. 5B enables the first replicator 520 and the mirror 530 to be provided as part of a first relatively thin layer in a plane in the first and third dimensions (illustrated as an x-z plane). In particular, the size or “height” of a first planar layer—in which the first replicator 520 is located—in the second dimension (illustrated as the y dimension) is reduced. The mirror 530 is configured to direct the light away from a first layer/plane, in which the first replicator 520 is located (i.e. the “first planar layer”), and direct it towards a second layer/plane, located above and substantially parallel to the first layer/plane, in which the second replicator 540 is located (i.e. a “second planar layer”). Thus, the overall size or “height” of the system-comprising the first and second replicators 520, 540 and the mirror 530 located in the stacked first and second planar layers in the first and third dimensions (illustrated as an x-z plane)—in the second dimension (illustrated as the y dimension) is compact. The skilled reader will understand that many variations of the arrangement of FIG. 5B for implementing the present disclosure are possible and contemplated.

The image projector may be arranged to project a diverging or diffracted light field. In some embodiments, the light field is encoded with a hologram. In some embodiments, the diffracted light field comprises diverging ray bundles. In some embodiments, the image formed by the diffracted light field is a virtual image.

In some embodiments, the first pair of parallel/complementary surfaces are elongate or elongated surfaces, being relatively long along a first dimension and relatively short along a second dimension, for example being relatively short along each of two other dimensions, with each dimension being substantially orthogonal to each of the respective others. The process of reflection/transmission of the light between/from the first pair of parallel surfaces is arranged to cause the light to propagate within the first waveguide pupil expander, with the general direction of light propagation being in the direction along which the first waveguide pupil expander is relatively long (i.e., in its “elongate” direction).

There is disclosed herein a system that forms an image using diffracted light and provides an eye-box size and field of view suitable for real-world application—e.g. in the automotive industry by way of a head-up display. The diffracted light is light forming a holographic reconstruction of the image from a diffractive structure—e.g. hologram such as a Fourier or Fresnel hologram. The use diffraction and a diffractive structure necessitates a display device with a high density of very small pixels (e.g. 1 micrometer)—which, in practice, means a small display device (e.g. 1 cm). The inventors have addressed a problem of how to provide 2D pupil expansion with a diffracted light field e.g. diffracted light comprising diverging (not collimated) ray bundles.

In some embodiments, the display system comprises a display device-such as a pixelated display device, for example a spatial light modulator (SLM) or Liquid Crystal on Silicon (LCoS) SLM—which is arranged to provide or form the diffracted or diverging light. In such aspects, the aperture of the spatial light modulator (SLM) is a limiting aperture of the system. That is, the aperture of the spatial light modulator—more specifically, the size of the area delimiting the array of light modulating pixels comprised within the SLM—determines the size (e.g. spatial extent) of the light ray bundle that can exit the system. In accordance with this disclosure, it is stated that the exit pupil of the system is expanded to reflect that the exit pupil of the system (that is limited by the small display device having a pixel size for light diffraction) is made larger or bigger or greater in spatial extend by the use of at least one pupil expander.

The diffracted or diverging light field may be said to have “a light field size”, defined in a direction substantially orthogonal to a propagation direction of the light field. Because the light is diffracted/diverging, the light field size increases with propagation distance.

In some embodiments, the diffracted light field is spatially-modulated in accordance with a hologram. In other words, in such aspects, the diffractive light field comprises a “holographic light field”. The hologram may be displayed on a pixelated display device. The hologram may be a computer-generated hologram (CGH). It may be a Fourier hologram or a Fresnel hologram or a point-cloud hologram or any other suitable type of hologram. The hologram may, optionally, be calculated so as to form channels of hologram light, with each channel corresponding to a different respective portion of an image that is intended to be viewed (or perceived, if it is a virtual image) by the viewer. The pixelated display device may be configured to display a plurality of different holograms, in succession or in sequence. Each of the aspects and embodiments disclosed herein may be applied to the display of multiple holograms.

The output port of the first waveguide pupil expander may be coupled to an input port of a second waveguide pupil expander. The second waveguide pupil expander may be arranged to guide the diffracted light field-including some of, preferably most of, preferably all of, the replicas of the light field that are output by the first waveguide pupil expander—from its input port to a respective output port by internal reflection between a third pair of parallel surfaces of the second waveguide pupil expander.

The first waveguide pupil expander may be arranged to provide pupil expansion, or replication, in a first direction and the second waveguide pupil expander may be arranged to provide pupil expansion, or replication, in a second, different direction. The second direction may be substantially orthogonal to the first direction. The second waveguide pupil expander may be arranged to preserve the pupil expansion that the first waveguide pupil expander has provided in the first direction and to expand (or, replicate) some of, preferably most of, preferably all of, the replicas that it receives from the first waveguide pupil expander in the second, different direction. The second waveguide pupil expander may be arranged to receive the light field directly or indirectly from the first waveguide pupil expander. One or more other elements may be provided along the propagation path of the light field between the first and second waveguide pupil expanders.

The first waveguide pupil expander may be substantially elongated and the second waveguide pupil expander may be substantially planar. The elongated shape of the first waveguide pupil expander may be defined by a length along a first dimension. The planar, or rectangular, shape of the second waveguide pupil expander may be defined by a length along a first dimension and a width, or breadth, along a second dimension substantially orthogonal to the first dimension. A size, or length, of the first waveguide pupil expander along its first dimension make correspond to the length or width of the second waveguide pupil expander along its first or second dimension, respectively. A first surface of the pair of parallel surfaces of the second waveguide pupil expander, which comprises its input port, may be shaped, sized, and/or located so as to correspond to an area defined by the output port on the first surface of the pair of parallel surfaces on the first waveguide pupil expander, such that the second waveguide pupil expander is arranged to receive each of the replicas output by the first waveguide pupil expander.

The first and second waveguide pupil expander may collectively provide pupil expansion in a first direction and in a second direction perpendicular to the first direction, optionally, wherein a plane containing the first and second directions is substantially parallel to a plane of the second waveguide pupil expander. In other words, the first and second dimensions that respectively define the length and breadth of the second waveguide pupil expander may be parallel to the first and second directions, respectively, (or to the second and first directions, respectively) in which the waveguide pupil expanders provide pupil expansion. The combination of the first waveguide pupil expander and the second waveguide pupil expander may be generally referred to as being a “pupil expander”.

It may be said that the expansion/replication provided by the first and second waveguide expanders has the effect of expanding an exit pupil of the display system in each of two directions. An area defined by the expanded exit pupil may, in turn define an expanded eye-box area, from which the viewer can receive light of the input diffracted or diverging light field. The eye-box area may be said to be located on, or to define, a viewing plane.

The two directions in which the exit pupil is expanded may be coplanar with, or parallel to, the first and second directions in which the first and second waveguide pupil expanders provide replication/expansion. Alternatively, in arrangements that comprise other elements such as an optical combiner, for example the windscreen (or, windshield) of a vehicle, the exit pupil may be regarded as being an exit pupil from that other element, such as from the windscreen. In such arrangements, the exit pupil may be non-coplanar and non-parallel with the first and second directions in which the first and second waveguide pupil expanders provide replication/expansion. For example, the exit pupil may be substantially perpendicular to the first and second directions in which the first and second waveguide pupil expanders provide replication/expansion.

The viewing plane, and/or the eye-box area, may be non-coplanar or non-parallel to the first and second directions in which the first and second waveguide pupil expanders provide replication/expansion. For example, a viewing plane may be substantially perpendicular to the first and second directions in which the first and second waveguide pupil expanders provide replication/expansion.

In order to provide suitable launch conditions to achieve internal reflection within the first and second waveguide pupil expanders, an elongate dimension of the first waveguide pupil expander may be tilted relative to the first and second dimensions of the second waveguide pupil expander.

### Combiner Shape Compensation

An advantage of projecting a hologram to the eye-box is that optical compensation can be encoded in the hologram (see, for example, European patent 2936252 incorporated herein by herein). The present disclosure is compatible with holograms that compensate for the complex curvature of an optical combiner used as part of the projection system. In some embodiments, the optical combiner is the windscreen of a vehicle. Full details of this approach are provided in European patent 2936252 and are not repeated here because the detailed features of those systems and methods are not essential to the new teaching of this disclosure herein and are merely exemplary of configurations that benefit from the teachings of the present disclosure.

### Control Device

The present disclosure is also compatible with optical configurations that include a control device (e.g. light shuttering device) to control the delivery of light from a light channelling hologram to the viewer. The holographic projector may further comprise a control device arranged to control the delivery of angular channels to the eye-box position. British patent application 2108456.1, filed 14 Jun. 2021 and incorporated herein by reference, discloses the at least one waveguide pupil expander and control device. The reader will understand from at least this prior disclosure that the optical configuration of the control device is fundamentally based upon the eye-box position of the user and is compatible with any hologram calculation method that achieves the light channeling described herein. It may be said that the control device is a light shuttering or aperturing device. The light shuttering device may comprise a 1D array of apertures or windows, wherein each aperture or window independently switchable between a light transmissive and a light non-transmissive state in order to control the delivery of hologram light channels, and their replicas, to the eye-box. Each aperture or window may comprise a plurality of liquid crystal cells or pixels.

### Footprint Overlap in Corrective Glare Mitigation Devices

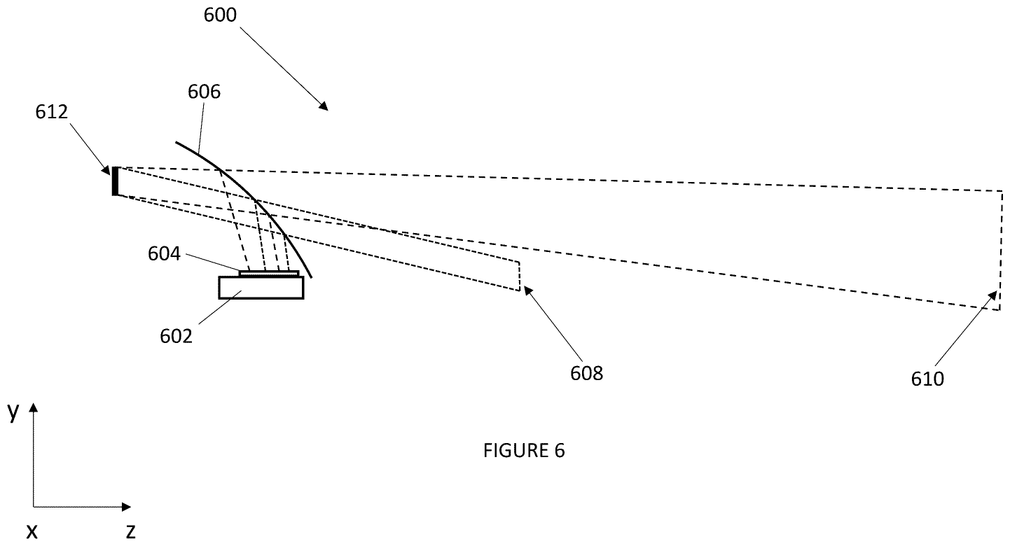

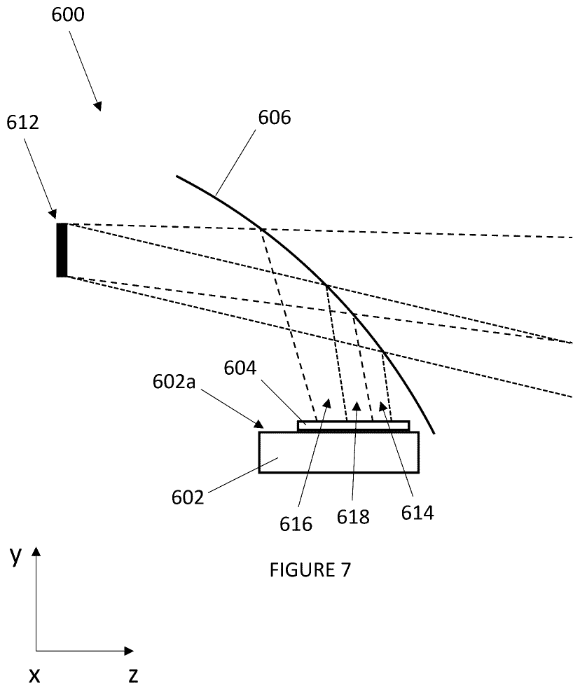

FIG. 6 shows a (head-up) display system 600 according to the prior art with a waveguide 602 (or, more broadly, a replicator 602) as per the second waveguide 540 described above in relation to FIG. 5B. FIG. 7 shows an enlarged partial view of the system 600. Waveguide 602 has an output surface 602a from which the replicas are emitted.

Positioned above the waveguide 602 (i.e. downstream of the waveguide 602 in the y-direction) is a corrective glare mitigation device 604 (or, more broadly, a light control device 604). The corrective glare mitigation device 604 serves two main roles to the system 600.

Firstly, the corrective glare mitigation device 604 prevents or mitigates sunlight glare that would otherwise reflect off the output surface 602a and towards the user/viewer. For example, the corrective glare mitigation device 604 may comprise carefully designed and angled louvres that allow display light pass through the corrective glare mitigation device 604 whilst dealing with the different sunlight angles for different times of the day in different ways. This is further described, for example, in UK patent number GB2607672. In other words, the corrective glare mitigation device 604 does this by absorbing the sunlight that would be directed towards the user whilst allowing the replicas emitted from the output surface 602a to pass therethrough.

Secondly, in this embodiment, the corrective glare mitigation device 604 compensates for the curvature of a curved optical component 606, which may be a windscreen of a vehicle or other optical combiner, and has a non-uniform optical power. For example, the corrective glare mitigation device 604 may comprise a layer (or a pair of layers) of prisms that effectively combine to act as a composite lens having an opposite lensing effect of the curved optical component 606 causing unwanted distortions (e.g. the windscreen/windshield). In this way, the distortion applied by the corrective glare mitigation device 604 can be selected to at least partially if not exactly compensate (or pre-compensate) for another source of distortion caused by the curved optical component 606 (e.g. the windscreen/windshield). In other words, the corrective glare mitigation device 604 does this by purposefully applying a distortion to the replicas that has an opposite optical power to that of the curved optical component 606, thereby removing or mitigating any distortion that would be visible to the user.

FIGS. 6 and 7 show what would happen if a display device 600 according to the prior art were to be used to attempt to display images on two different planes, a near plane 608 and a far plane 610 (or indeed any number of planes in a multi-plane system). The planes 608, 610 are parallel to one another, with the near plane 608 being closer to an eye-box 612 (i.e. a viewing window) than the far plane 610 in the z-direction.

The corrective glare mitigation device 604 has a first footprint that is formed from a first light ray bundle 614 on a first area of the corrective glare mitigation device 604, the first footprint intended to form an image on the near plane 608 and a second footprint that is formed from a second light ray bundle 616 on a second area of the corrective glare mitigation device 604, the second footprint intended to form an image on the far plane 610. The light 614, 616 is emitted towards the curved optical component 606 and reflected therefrom towards the eye-box 612, with the intention that the light 614, 616 appears to have originated from beyond said curved optical component 606 in the z-direction (i.e. on, or at, the near and far planes 608, 610). However, due to the need to have this light 614, 616 be visible across the whole of the eye-box 612 (to ensure that the entire field-of-view of the displayed images is visible to the user throughout the eye-box 612), the footprints on the corrective glare mitigation device 604 are relatively large compared to the surface area of an output surface of the corrective glare mitigation device 604. This results in an overlap in the footprints and therefore in an overlap region 618 between (in other words, of) the first light ray bundle 614 and second light ray bundle 616. This overlap region 618 prevents images from forming at one or both of the near plane 608 and the far plane 610.

Reducing the size of the footprints on the corrective glare mitigation device 604 would hence reduce the width of the light ray bundles 614, 616 and therefore reduce the overlap region 618. However, this would reduce the size of the eye-box 612 and therefore reduce the amount the user could move their head before reaching the edge of the eye-box 612 and without perceiving the displayed images at a reduced quality, with an increased number of anomalies/distortions, or not perceiving the images at all. Maintaining the size of the footprints on the corrective glare mitigation device 604 and designing said corrective glare mitigation device 604 to compensate for the effect the curved optical component 606 has on images in multiple planes for multiple eye-box positions would be prohibitively complex.

### Multi-Plane Corrective Glare Mitigation Device

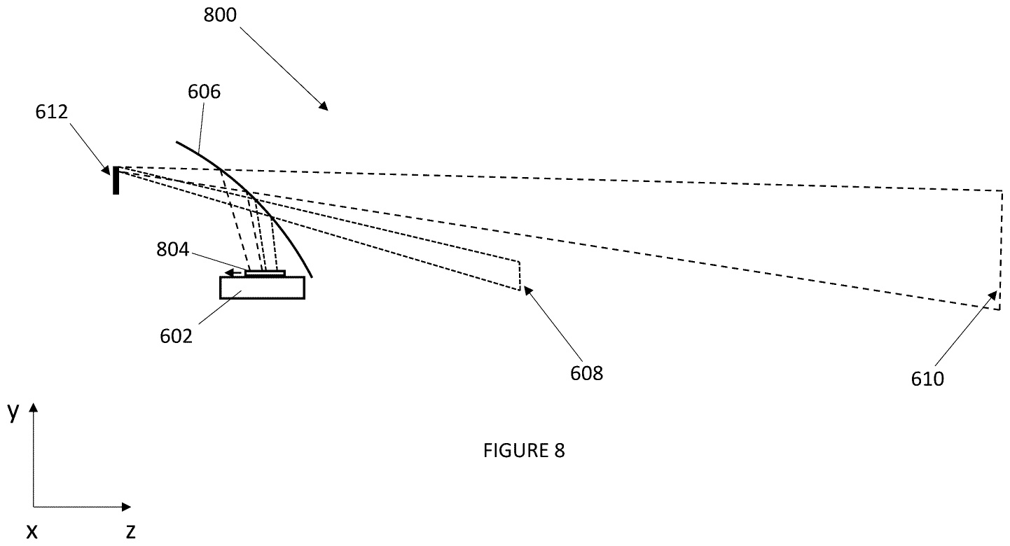

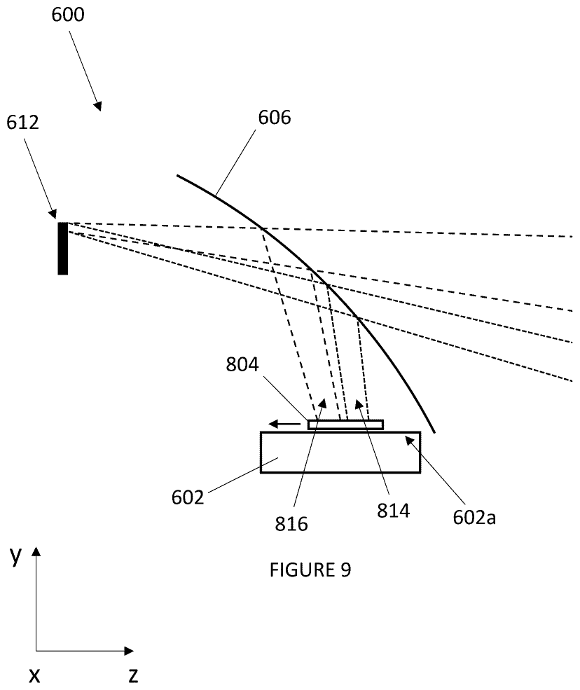

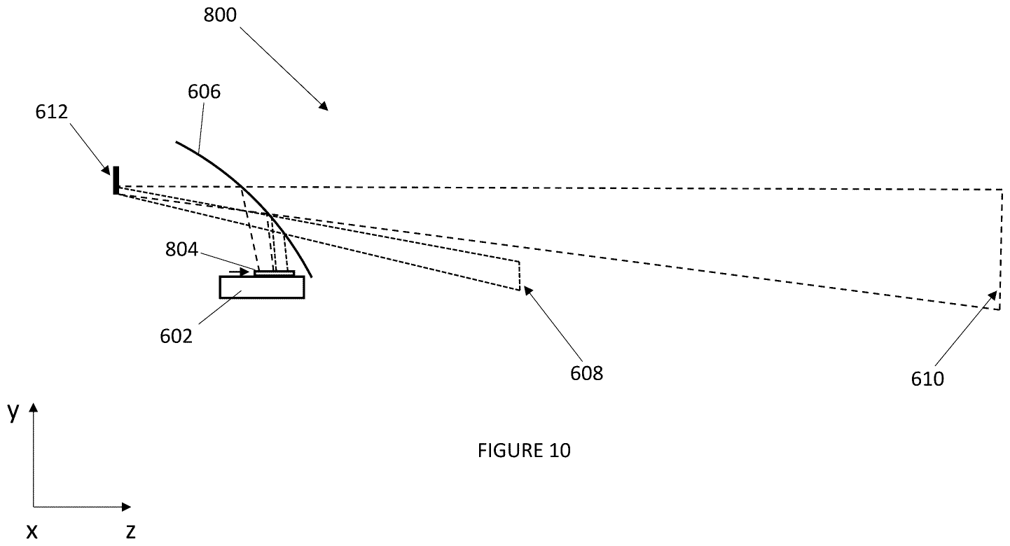

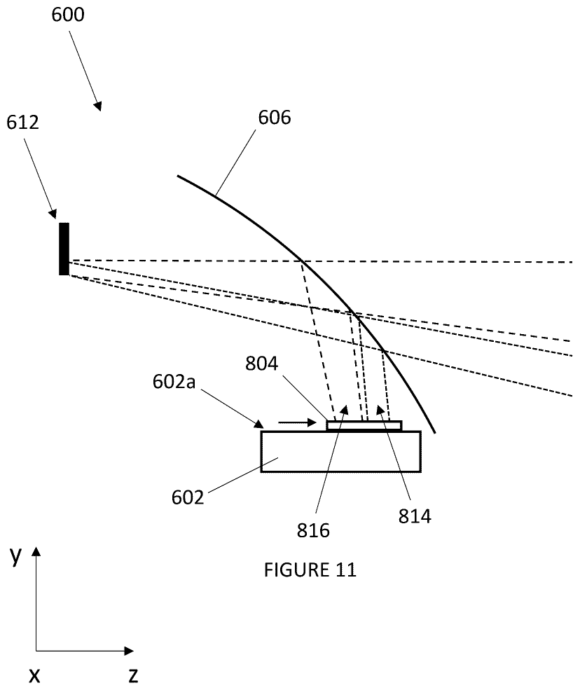

FIGS. 8, 9, 10 and 11 show a (head-up) display system 800 according to the present disclosure. As described above in relation to FIG. 6, the display system 800 has a waveguide 602 and curved optical component 606 arranged to display images at a near plane 608 and a far plane 610 formed at an eye-box 612. The system 800 further comprises a corrective glare mitigation device 804 that performs the same glare mitigation and curved optical component correction functions as described above. Specifically, FIGS. 8 and 9 show the system 800 in a first position, whilst FIGS. 10 and 11 show the system 800 in a second position. FIGS. 9 and 11 show an enlarged partial views of the system 800 in the first and second positions respectively.

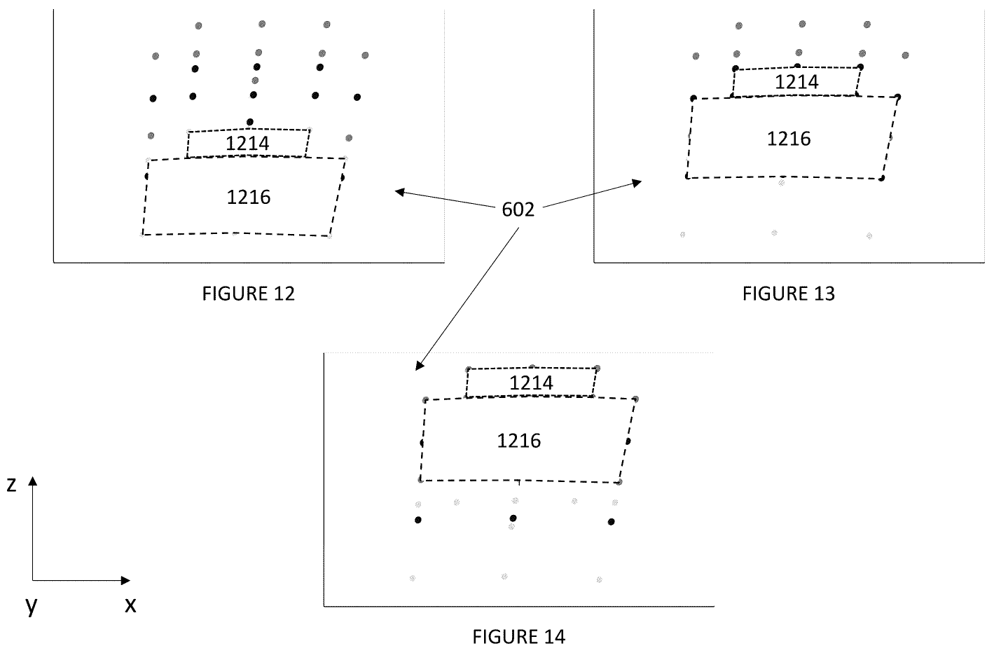

The corrective glare mitigation device 804 according to the present disclosure achieves what the corrective glare mitigation device 604 according to the prior art (as described above) can not. That is, the corrective glare mitigation device 804 according to the present disclosure has a first footprint that is formed on a first area of the corrective glare mitigation device 804 from a first light ray bundle 814 forming an image on the near plane 608 and a second footprint that is formed on a second area of the corrective glare mitigation device 804 that forms a second light ray bundle 816 forming an image on the far plane 610. These footprints are further described below in relation to FIGS. 12, 13, 14, 15 and 16. Unlike in the system 600 of the prior art, the footprints on the corrective glare mitigation device 804 of the present disclosure are spatial separated such that there is no overlap between them. As a result, there is no overlap region present between the first and second light ray bundles 814, 816, as they are emitted from the corrective glare mitigation device 804. This allows the images to be formed correctly at both the near and far planes 608, 610.

However, as can be seen for example in FIG. 9, this separation of the footprints reduces the width of the light ray bundles 814, 816 (due to the reduced size of the footprints), resulting in a reduced area of the eye-box 612 to which the light ray bundles 814, 816 are reflected (or relayed) from the curved optical component 606. The first position of FIGS. 8 and 9 is when the corrective glare mitigation device 804 is in a location relative to the output surface 602a of the waveguide 602 such that the light ray bundles 814, 816 are reflected from the curved optical component 606 to the top of the eye-box 612. That is, the images displayed by the system 800 are most clearly visible to their user when their eyes are towards the top of the eye-box 612 (in the y-direction) when the system 800 is in the first position. Meanwhile, the second position of FIGS. 10 and 11 is when the corrective glare mitigation device 804 is in a location relative to the output surface 602a of the waveguide 602 such that the light ray bundles 814, 816 are reflected from the curved optical component 606 to the bottom of the eye-box 612. That is, the images displayed by the system 800 are most clearly visible to their user when their eyes are towards the bottom of the eye-box 612 (in the y-direction) when the system 800 is in the second position.

In order to provide a sufficient quality of image displayed across the full area of the eye-box 612, the corrective glare mitigation device 804 is arranged such that it is moveable between the first and second positions. In other words, the corrective glare mitigation device 804 is moveable in the z-direction (that is, towards and away from the user and the eye-box 612). This may be, for example, by a driver or other such linear actuator (not shown) suitable for providing the necessary translational movement. In this way, the corrective glare mitigation device 804 can be positioned such that the light ray bundles 814, 816 are reflected from the curved optical component 606 to the user regardless of their position within the (in other words, relative to) the eye-box 612.

As the corrective glare mitigation device 804 moves relative to the waveguide 602, the light ray bundles 814, 816 will reflect off different areas of the curved optical component 612. As the geometry of the curvature of the curved optical component 612 may change across the surface of the component 612, this would normally require that any corrective glare mitigation device apply a varying correction across its surface, to account for said change in the curvature geometry. In the present disclosure, the corrective glare mitigation device 804 is comparatively smaller and so cannot provide such a correction. However, the inventors have surprisingly found that any minor optical distortion caused by the changing of the curvature of the curved optical component 606 as the corrective glare mitigation device 804 moves is outweighed by the benefit of being able to display images in both the near and far planes 608, 610 simultaneously across the full field-of-view.

The movement of the corrective glare mitigation device 804 may happen continuously during use, or at the start-up of the display system 800, or both. That is, the corrective glare mitigation device 804 may move to adjust the part of the eye-box 612 to which the light ray bundles 814, 816 are reflected corresponding to the movement of the user within the eye-box 612. This may be achieved using an eye-tracking system to determine the position of the user's eyes within (or relative to) the eye-box 612 and moving the corrective glare mitigation device 804 accordingly. This allows the images to be displayed in both the near and far planes 608, 610 simultaneously across the full field-of-view as the user moves during use of the eye-box 612. Additionally, or alternatively, the corrective glare mitigation device 804 may be moved on start-up of the display system 800 to account for factors such as the user's seat position of a vehicle. This may be achieved by calculating the required corrective glare mitigation device 804 position based on inputted data relating to the seat position, or by using the aforementioned eye-tracking system.

Although FIGS. 8, 9, 10 and 11 are shown with the corrective glare mitigation device 804 moving in one direction (the z-direction), this is for the sake of the simplicity of the Figures only. Movement of the corrective glare mitigation device 804 could additionally (or alternatively) happen in the x-direction to account for movement of the user in the x-direction within (or relative to) the eye-box 612. Similarly, although FIGS. 8, 9, 10 and 11 show the display system 800 as a dual-plane system, it is also envisaged that the present disclosure could be used to produce a multi-plane system. That is, in addition to the first and second light ray bundles 814, 816, further light ray bundles could be emitted from the corrective glare mitigation device 804 to display images at planes other than the near and far planes 608, 610.

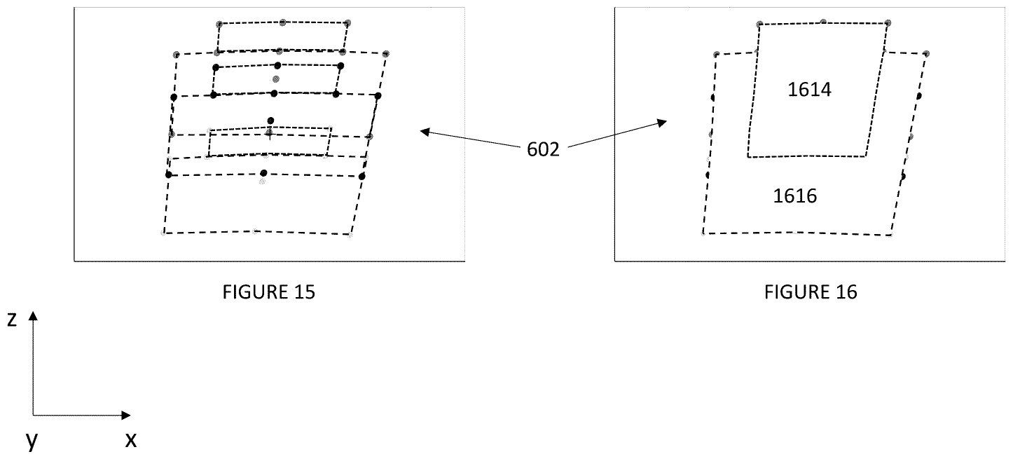

FIG. 12 shows a graphical representation of the replicator 602 with a first footprint 1214 and a second footprint 1216 in a first position. These footprints 1214, 1216 are as described above and it is these first and second footprints 1214, 1216 that are formed by the first and second light ray bundles 814, 816. As described above, the footprints 1214, 1216 are spatially sperate—this is, they do no overlap on the x-y plane (the plane of the replicator 602 and the corrective glare mitigation device 804). FIG. 14 shows the footprints 1214, 1216 in the second position, whilst FIG. 13 shows the footprints 1214, 1216 in a third position between the first and second positions. FIG. 15 shows the overlap between the footprints 1214, 1216 in the three positions that would be visible if looking in the negative y-direction towards the replicator 602. Finally, FIG. 16 shows the summation of these positions.

FIGS. 12, 13, 14, 15 and 16 are purely by example only. For example, features such as the shape, size and aspect ratio of each footprint 1214, 1216 may be different as required to display the desired images at the desired planes. Furthermore, the footprints 1214, 1216 may be abutting or may be separated by a gap therebetween. Similarly, as described above, although only two footprints 1214, 1216 are shown for displaying images on two planes 608, 610, the use of further footprints to display images on further planes is also envisaged. Finally, as described above, although only movement of the footprints 1214, 1216 in the z-direction is shown, movement in the x-direction is also envisaged.

### Additional Features

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

What is claimed is:

1. A display system comprising a viewing window and arranged to project a first image on a first plane and project a second image on a second plane, wherein the display system comprises:
a replicator arranged to receive spatially modulated light and replicate the spatially modulated light to form a plurality of replicas of the spatially modulated light by waveguiding between a reflective surface and a transmissive-reflective surface, the transmissive-reflective surface forming an output surface for the plurality of replicas of the spatially modulated light;
a light control device located in an optical path of the plurality of replicas of the spatially modulated light downstream from the output surface of the replicator, the light control device comprising a first area and a second area, wherein a first plurality of replicas of the first image form a first light footprint on the first area and a second plurality of replicas of the second image form a second light footprint on the second area, the first and second areas being spatial separate; and
a driver arranged to move the light control device relative to the replicator.

2. The display system of claim 1, further comprising a non-uniform optical component downstream from the light control device, wherein the light control device is arranged to compensate for the non-uniformity of the non-uniform optical component.

3. The display system of claim 2, wherein an optical power of the light control device is associated with an average position of a user relative to the viewing window or a centre of the viewing window.

4. The display system of claim 2, wherein the light control device has optical power substantially inverse to that of the non-uniform optical component.

5. The display system of claim 2, wherein the first plane is spatial separate from the second plane in a direction parallel to optical path of the replicas from the non-uniform optical component to the viewing window.

6. The display system of claim 1, wherein movement of the light control device is on a plane parallel to a plane of the output surface of the replicator.

7. The display system of claim 2, wherein movement of the light control device has a component in a direction parallel to optical path of the replicas from the non-uniform optical component to the viewing window.

8. The display system of claim 1, wherein movement of the light control device is between a first position and a second position, the first position being such that the replicas are relayed to proximate a first edge of the viewing window and the second position being such that the replicas are relayed to proximate a second edge of the viewing window, the first edge of the viewing window being arranged opposite the second edge.

9. The display system of claim 1, further comprising an eye-tracking system arranged to track a position of at least one of a user's eyes relative to the viewing window, wherein movement of the light control device is dependent on said position.

10. The display system of claim 1, wherein a position of the light control device is dependent on user position data received by the driver.

11. A method of operating a head-up display to project a first image on a first plane and project a second image on a second plane, wherein the method comprises:
replicating, via a replicator, spatially modulated light corresponding to the first image and the second image to form a plurality of replicas of the spatially modulated light by waveguiding between a reflective surface and a transmissive-reflective surface;
illuminating a light control device with the replicas of the spatially modulated light corresponding to the first image and the second image, a first plurality of replicas of the first image forming a first light footprint on a first area of the light control device and a second plurality of replicas of the second image forming a second light footprint on a second area of the light control device, wherein the first and second areas are spatially separated;
relaying the replicas of the spatially modulated light corresponding to the first and second images to a viewing window using an optical component having non-uniform optical power; and
moving the light control device relative to the replicator.

12. The method of claim 11, further comprising:
moving the light control device before illuminating the light control device.

13. The method of claim 12, further comprising:
receiving user positioning data, wherein moving the light control device is dependent on the user positioning data.

14. The method of claim 11, further comprising:
moving the light control device after relaying the replicas of the spatially modulated light corresponding to the first and second images to the viewing window.

15. The method of claim 14, further comprising:
receiving data from an eye-tracking system arranged to track a position of at least one of a user's eyes relative to the viewing window, wherein the moving the light control device is dependent on the position of at least one of a user's eyes relative to the viewing window.

16. Tangible, non-transitory computer-readable media comprising program instructions stored therein, wherein the program instructions, when executed by one or more processors, cause a display system to project a first image on a first plane and project a second image on a second plane via functions comprising:
replicating, via a replicator, spatially modulated light corresponding to the first image and the second image to form a plurality of replicas of the spatially modulated light by waveguiding between a reflective surface and a transmissive-reflective surface;
illuminating a light control device with the replicas of the spatially modulated light corresponding to the first image and the second image, a first plurality of replicas of the first image forming a first light footprint on a first area of the light control device and a second plurality of replicas of the second image forming a second light footprint on a second area of the light control device, wherein the first and second areas are spatially separated;
relaying the replicas of the spatially modulated light corresponding to the first and second images to a viewing window using an optical component having non-uniform optical power; and
moving the light control device relative to the replicator.

17. The tangible, non-transitory computer-readable media of claim 16, wherein the functions further comprise:
moving the light control device before illuminating the light control device.

18. The tangible, non-transitory computer-readable media of claim 17, wherein the functions further comprise:
receiving user positioning data, wherein moving the light control device is dependent on the user positioning data.

19. The tangible, non-transitory computer-readable media of claim 16, wherein the functions further comprise:
moving the light control device after relaying the replicas of the spatially modulated light corresponding to the first and second images to the viewing window.

20. The tangible, non-transitory computer-readable media of claim 19, wherein the functions further comprise:
receiving data from an eye-tracking system arranged to track a position of at least one of a user's eyes relative to the viewing window, wherein the moving the light control device is dependent on the position of at least one of a user's eyes relative to the viewing window.
